(19) United States
(12) Patent Application Publication
(10) Pub. No.: US 2026/0061463 A1
(43) Pub. Date: Mar. 5, 2026

(54) METHOD AND DEVICE FOR CLEANING SEMICONDUCTOR MANUFACTURING TOOL

(71) Applicant: TAIWAN SEMICONDUCTOR MANUFACTURING COMPANY LTD., HSINCHU (TW)

(72) Inventor: CHENG-TING LU, HSINCHU CITY (TW)

(21) Appl. No.: 18/823,743

(22) Filed: Sep. 4, 2024

(51) Int. Cl. B08B 5/02; H01L 21/673; H01L 21/677

(52) U.S. Cl. CPC B08B 5/02

(57) ABSTRACT

A semiconductor manufacturing system is provided. The system includes a semiconductor process tool. The semiconductor process tool includes a load port including a plurality of positioning pins positioned on a top surface thereof. The system further includes a cleaning device used to be positioned on the load port. The cleaning device include a housing, a gas driving member, and a number of gas guides. The housing has a lower plate. The gas driving member is positioned in the housing. The gas guides are positioned on the lower plate of the housing and fluidly connected to the gas driving member. When the cleaning device is positioned on the load port, each of the positioning pins of the load port is covered by and surrounded by the lower opening of one of the gas guides.

### BACKGROUND

The semiconductor integrated circuit (IC) industry has experienced rapid growth. Technological advances in IC materials and design have produced generations of ICs where each generation has smaller and more complex circuits than the previous generation. However, these advances have increased the complexity of processing and manufacturing ICs, and similar developments in IC processing and manufacturing are needed. In the course of IC evolution, functional density (i.e., the number of interconnected devices per chip area) has generally increased while geometry size (i.e., the smallest component (or line) that can be created using a fabrication process) has decreased. This scaling down process generally provides benefits by increasing production efficiency and lowering associated costs.

As the sizes of semiconductor integrated circuits and the design rule for line widths have decreased, the issue of contamination of the devices and substrates (or wafers) during processing has become more important. The demand for extremely clean processing environments for these devices and substrates has increased.

### BRIEF DESCRIPTION OF THE DRAWINGS

Aspects of the embodiments of the present disclosure are best understood from the following detailed description when read with the accompanying figures. It is noted that, in accordance with the standard practice in the industry, various structures are not drawn to scale. In fact, the dimensions of the various structures may be arbitrarily increased or reduced for clarity of discussion.

FIG. 1 is a schematic view illustrating an automatic system and a semiconductor process tool, according to some embodiments of the present invention.

FIG. 2 is a perspective view depicting a wafer carrier and a load port of the semiconductor process tool of FIG. 1, according to some embodiments of the present invention.

FIG. 3 is a schematic view illustrating the automatic system and the semiconductor process tool when a door of the wafer carrier is open, according to some embodiments of the present invention.

FIG. 4 is a schematic view depicting a cleaning device, according to some embodiments of the present invention.

FIG. 5 is a schematic cross-sectional view illustrating partial elements of the cleaning device when placed on a top surface of the load port, according to some embodiments of the present invention.

FIG. 6 is a schematic bottom view depicting the cleaning device, according to some embodiments of the present invention.

FIGS. 7 and 8 are schematic views illustrating various cleaning devices, according to some embodiments of the present invention.

FIGS. 9 and 10 are schematic bottom views depicting various cleaning devices, according to some embodiments of the present invention.

FIGS. 11 and 12 are schematic views illustrating gas flow passing through partial elements of the cleaning device, according to some embodiments of the present invention.

FIG. 13 is a flow chart depicting a method for cleaning a semiconductor manufacturing tool, according to some embodiments of the present invention.

FIGS. 14-16 are schematic views illustrating stages of the method for cleaning the semiconductor manufacturing tool, according to some embodiments of the present invention.

FIG. 17 is a schematic view illustrating gas flow is driven through a first group of gas guides, according to some embodiments of the present invention.

FIG. 18 is a schematic view illustrating gas flow passing through partial elements of the cleaning device, according to some embodiments of the present invention.

FIG. 19 is a schematic view depicting particles being captured in the cleaning device, according to some embodiments of the present invention.

FIG. 20 is a schematic view illustrating gas flow is driven through a second group of gas guides, respectively, according to some embodiments of the present invention.

### DETAILED DESCRIPTION

The following disclosure provides many different embodiments, or examples, for implementing different features of the provided subject matter. Specific examples of elements and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “over,” “upper,” “on,” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, the terms such as “first,” “second” and “third” describe various elements, components, regions, layers and/or sections, these elements, components, regions, layers and/or sections should not be limited by these terms. These terms may be only used to distinguish one element, component, region, layer or section from another. The terms such as “first,” “second” and “third” when used herein do not imply a sequence or order unless clearly indicated by the context.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation.

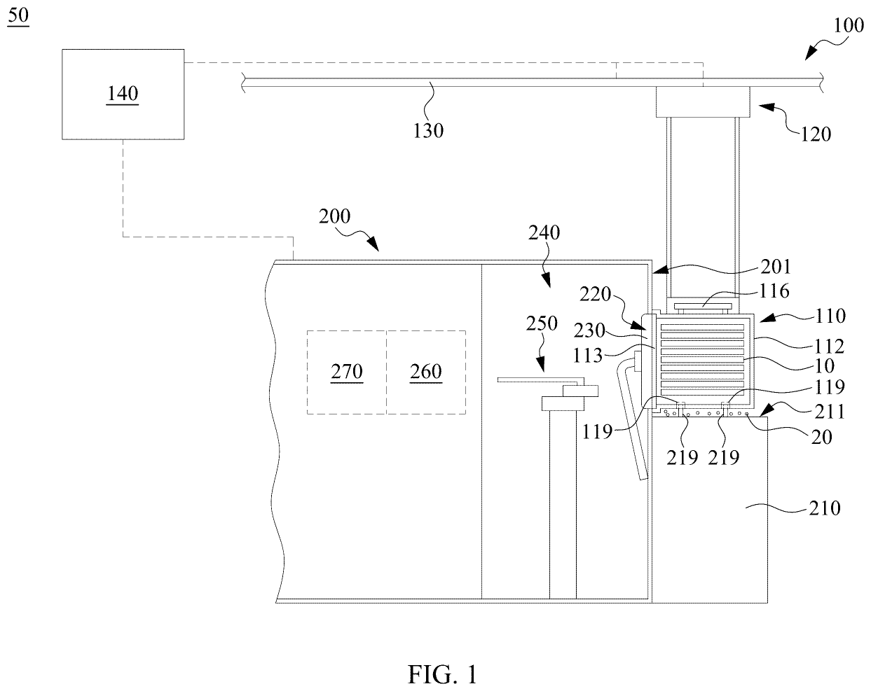

FIG. 1 is a schematic view of a semiconductor manufacturing system 50 which includes an automatic system 100 and a semiconductor process tool 200, in accordance with some embodiments. It should be noted that there may be a number of semiconductor process tools 200, but for the sake of simplicity, FIG. 1 merely show one of the semiconductor process tool 200.

As shown in FIG. 1, the automatic system 100 includes wafer carriers 110, a transport mechanism 120, a rail 130 and a system controller 140, in accordance with some embodiments. For the sake of simplicity, FIG. 1 merely show one of the wafer carriers 110, and the wafer carrier 110 is illustrated as follows. The other wafer carriers 110 not shown may have the same structure as the wafer carrier 110 shown in FIG. 1. The wafer carrier 110 is configured to carry a number of wafers 10. The wafer carrier 110 includes, for example, a front opening unified pod (FOUP). The wafer carrier 110 may include different FOUP sizes such as 130 millimeter (mm) or 450 mm. Other types and/or sizes of the wafer carrier 110 may be used.

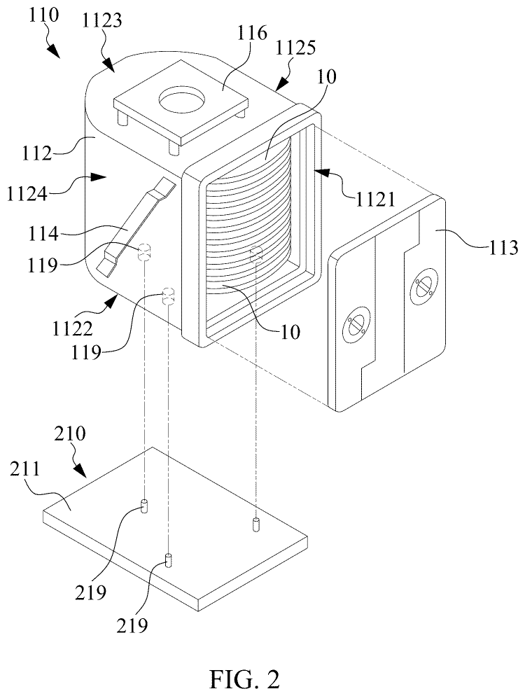

FIG. 2 is a perspective view of the wafer carrier 110 and the load port 210 of FIG. 1, in accordance with some embodiments. As shown in FIG. 1, the wafer carrier 110 includes a housing 112, handle grips 114, and a robotic flange (or a knob) 116, in accordance with some embodiments. The housing 112 may be a box-type housing including a front side 1121. A door 113 is detachably installed at the front side 1121 of the housing 112, in accordance with some embodiments. Specifically, the door 113 may be installed at the front side 1121 by a locking structure (not shown). The door 113 may be separated from the housing 112 when the locking structure is released by a door opener. The handle grips 114 are attached to opposite sides 1124 and 1125 of the housing 112 to facilitate carrying the wafer carrier 110. Because of the view angle of FIG. 2, the handle grip 114 attached to the side 1125 is not shown. The robotic flange 116 is installed on a top surface 1123 of the housing 112 so that the transport mechanism 120 can lift up the wafer carrier 110 by, for example, grasping the robotic flange 116.

Referring back to FIG. 1, the semiconductor process tool 200 is used for semiconductor fabrication. For example, the semiconductor process tool 200 includes, a deposition tool, an electroplating tool, an etch tool, a thermal furnaces, a developing tool, etc. The semiconductor process tool 200 has a load port 210, a gate 220, a door opener 230, a front chamber 240, a transfer robot 250, a load-lock chamber 260, and a process chamber 270, in accordance with some embodiments.

The load port 210 is equipped at a front side 201 of the semiconductor process tool 200 to be loaded with the wafer carrier 110. The gate 220 is formed at the front side 201 and is above the load port 210. The gate 220 is between the front chamber 240 and the exterior clean room where the wafer carrier 110 is transferred. The gate 220 is closed by the door opener 230 in the front chamber 240. The cleanness of the front chamber 240 should be kept high (e.g. class 100). The transfer robot 250 is disposed in the front chamber 240. The transfer robot 250 is configured to load the wafers 10 in the wafer carrier 110 into a load-lock chamber 260 or to unload the wafers 10 from the load-lock chamber 260 into the wafer carrier 110. The process chamber 270 is disposed at a rear portion of the load-lock chamber 260. The wafers 10 may be transferred from the load-lock chamber 260 to the process chamber 270 to be processed.

As shown in FIG. 1, the wafer carrier 110 may be loaded on the load port 210 by the transport mechanism 120. The transport mechanism 120 may be moveably disposed on the rail 130. The transport mechanism 120 may grasp the robotic flange 116 and move along the rail 130 to transfer the wafer carrier 110 to (or away from) the semiconductor process tool 200. The transport mechanism 120 includes, for example, an overhead hoist transfer (OHT) system. The transport mechanism 120 may also be referred as a wafer carrier transport mechanism.

The transport mechanism 120 is designed to perform a transportation controlled by the system controller 140. The system controller 140 is connected to the semiconductor process tools 200 and the transport mechanism 120 and/or the rail 130, in accordance with some embodiments. The system controller 140 controls the transport mechanism 120 to grasp the wafer carrier 110 and move to a desired position. The system controller 140 may receive signals from the semiconductor process tools 200. According to the signals, the system controller 140 controls the transport mechanism 120 to transfer the wafer carrier 110 with the wafers 10 therein to the semiconductor process tool 200 requiring the wafers 10. The system controller 140 may include a computer integrated manufacturing system (CIM system).

In some embodiments, as shown in FIG. 2, the housing 112 of the wafer carrier 110 includes multiple positioning holes 119 on its bottom surface 1122. The load port 210 has multiple positioning pins 219 on its top surface 211. These positioning pins 219 are designed to aid in the proper positioning of the wafer carrier 110 on the load port 210. When the wafer carrier 110 is placed on the load port 210, the bottom surface 1122 of the housing 112 aligns with the top surface 211 of the load port 210, and the door 113 of the wafer carrier 110 may be positioned to face the gate 220. Additionally, the positioning pins 219 are inserted into the positioning holes 119 on the wafer carrier 110.

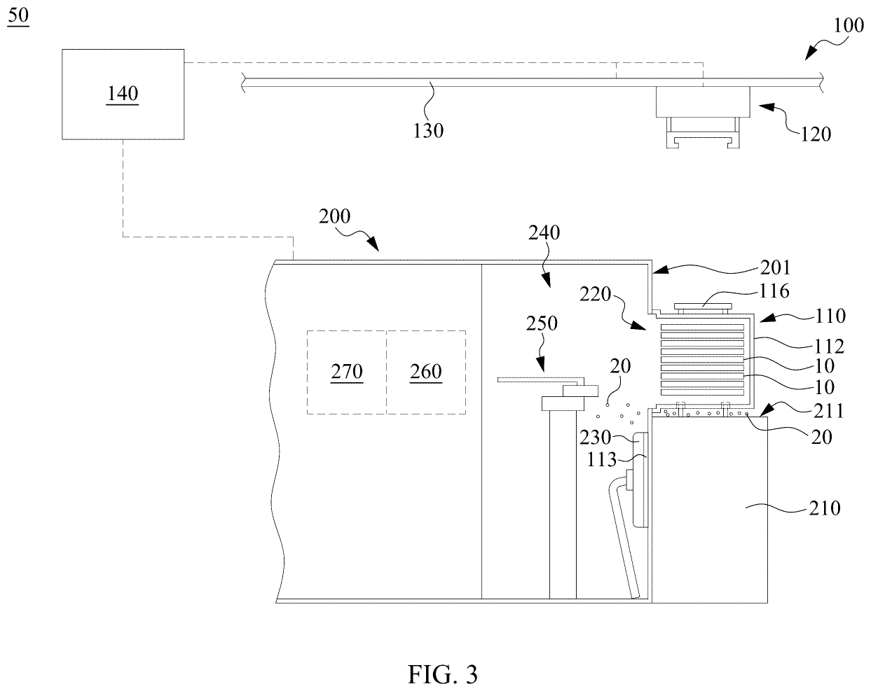

After the placement of the wafer carrier 110, as shown in FIG. 3, the door opener 230 opens the door 113 of the wafer carrier 110 and moves downwardly with the door 113, in accordance with some embodiments. Accordingly, the wafer carrier 110 is opened, and the wafers 10 are loaded into the semiconductor process tool 200. The gates 220, as well as the front chamber 240, are isolated from the exterior clean room by the housing 112 of the wafer carrier 110. In some embodiment, contaminants (e.g. dust or particles) 20 in the exterior clean room may be deposited on the top surface 211 of the load port 210. In some other embodiments, contaminants (e.g. dust or particles) 20 may be generated during the insertion of the positioning pins 219 into the positioning holes 119, which is should be avoided. When the wafer carrier 110 is opened, the particles 20 may float into the front chamber 240 and contaminate the front chamber 240 and the wafers 10.

In some embodiments, to solve this problem, the particles 20 are cleaned manually. However, the staffs need to walk in the exterior clean room to find out which of the load ports 210 are not occupied by the wafer carriers 110. The manual cleaning method takes a lot of time and there may be some load ports 210 missed being cleaned. Therefore, it is desired to find alternative mechanisms for timely cleaning the load port.

One objective of the present disclosure is to provide a cleaning device and a method for cleaning the load port to address the issues mentioned above. In various embodiments, the cleaning device may be removable from the load port. The cleaning device can be used to remove particles existing on the load port by creating a gas flow passing over the top surface of the load port. Example structures of the cleaning devices are described in more detail below.

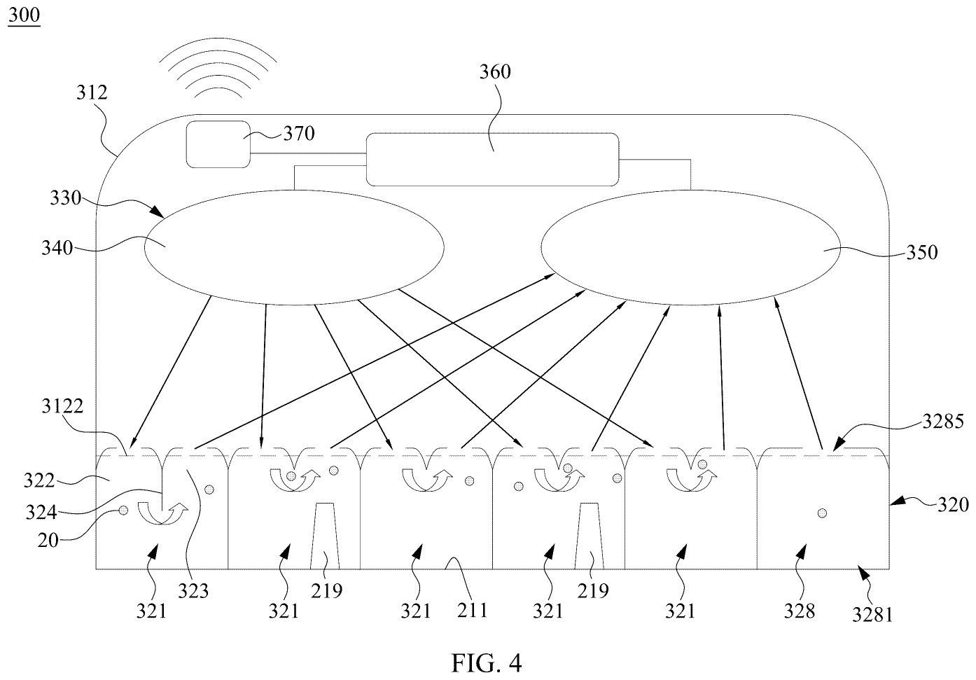

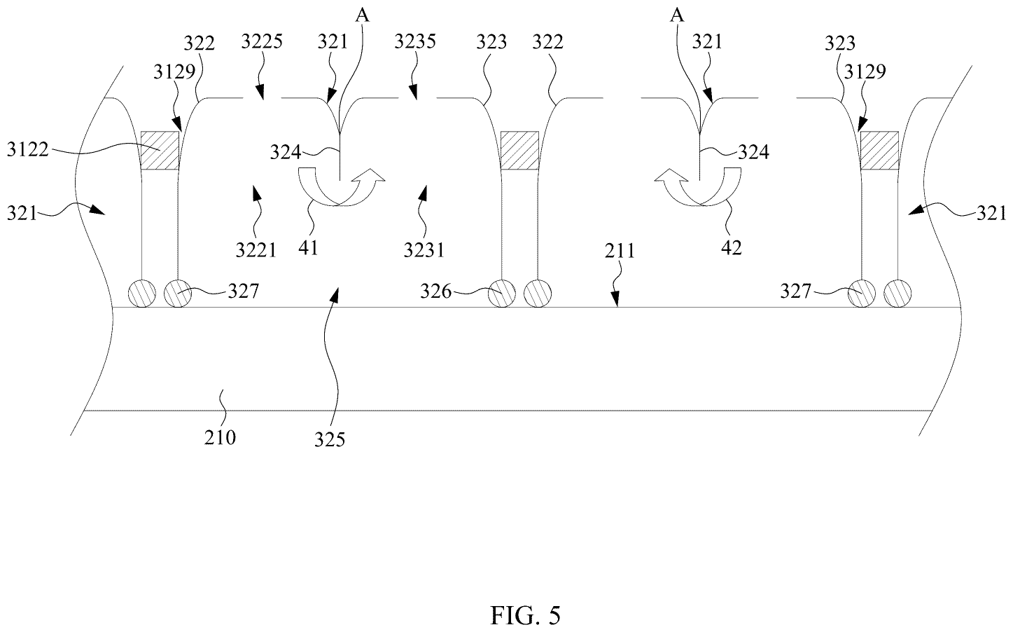

FIG. 4 schematically depicts one embodiment of a cleaning device 300 with positioning pins 219 inserted into a covering assembly 320. FIG. 5 is a cross-sectional view illustrating partial elements of the cleaning device 300 according to some embodiments. The cleaning device 300 may include components such as a housing 312, a covering assembly 320, a gas driving member 330, a controlling module 360, and a communication module 370.

The housing 312 can be a housing having a configuration similar to the wafer carrier 110 shown in FIG. 2, and sized to be placed on the load port 210. The housing 312 may further include features such as a robotic flange on its top surface to allow the transport mechanism 120 to manipulate the cleaning device 300. The housing 312 may have a lower plate 3122 defining a lower boundary of its interior. Components like the gas driving member 330, controlling module 360, and communication module 370 can be positioned above the lower plate 3122 within the interior of the housing 312.

The covering assembly 320 may be positioned on the lower plate 3122 in some embodiments. The covering assembly 320 can form the lowest part of the cleaning device 300 that contacts the load port 210 when placed on it. The covering assembly 320 can include one or more gas guides, such as gas guides 321 and 328, each configured to define a cleaning area on the load port 210. The lower plate 3122 may have features like a grid frame with through holes 3129 in which the gas guides can be positioned using various means such as fasteners, welds, or tight fit arrangements. The gas guides may be individual members not directly connected, or may have lower parts connected with upper parts independently inserted into the through holes 3129.

As shown in FIG. 5, a gas guide 321 may include structures such as a first guiding structure 322, a second guiding structure 323, and a diaphragm 324. The second guiding structure 323 is parallel and connected to the first guiding structure 322 along an intermediate axis A. The first and second guiding structures 322 and 323 can cooperatively define a hollow cover, for example in a semi-spherical shape with a lower opening 325. Gas holes 3225 and 3235 can be formed on tops of the first guiding structure 322 and the second guiding structure 323 to facilitate connection with gas tubes from the gas driving member 330.

The diaphragm 324 may extend along intermediate axis A at an inner surface of the gas guide 321 to partially separate the first and second guiding structures 322 and 323. The diaphragm 324 define first and second channels 3221 and 3231 extending perpendicular to the lower plate 3122. The diaphragm 324 can separate upper portions of the first and second channels 3221 and 3231. Its length in the height direction of the gas guide 321 may vary, with its lower free end distant from the lower opening 325. In some embodiments, a length of the diaphragm 324 in the height direction of the gas guide 321 is approximately 0.25 to 0.75 of the height of the gas guide 321. The diaphragm 324 forces gas from either gas hole 3225 or gas hole 3235 to flow towards the lower portion of the channel of the guiding structure before entering the adjacent channel of the other guiding structure. This increases the flow path of the gas in the gas guide 321 and directs the gas to flow through the lower opening 325 of the gas guide 321. In some embodiments, the diaphragm 324 may be omitted. Gas with a strong flow rate is supplied into the gas guide in order to reach the lower opening 325.

The sealing members 327 such as O-rings may surround the lower openings 325 of the gas guides to create an airtight seal against the top surface 211 of the load port 210 when the cleaning device 300 is placed on it. In some alternative embodiments, the sealing members 327 are omitted. The lower end of the gas guide 321 is in direct contact with the load port 210.

Referring back to FIG. 4, the gas guide 328 includes one guiding structure with a gas hole 3285 on its top for connecting to the gas tube of the gas driving member 330. The gas guide 328 is designed to have a hollow cover, which may be in the shape of a semi-sphere with a lower opening 3281. A sealing member (not shown in the figure) may be provided to surround the lower opening 3281 to create an airtight seal when the gas guide 328 is placed on the load port 210. In some embodiments, the gas guide 328 also include a filtration member 329 positioned on a side wall of the gas guide 328 to enable gas to enter the gas guide 328 or leave the gas guide 328.

The gas guides 321 and gas guides 328 of the covering assembly 320 may be made of pliable material with enough stiffness to support the weight of the cleaning device 300. In some embodiments, the gas guides may incorporate additional features, such as reinforcing ribs or varying wall thicknesses, to optimize their performance. The pliable nature of the gas guides can help ensure a good seal against the load port surface, while their stiffness prevents excessive deformation under the weight of the cleaning device. Suitable materials for the gas guides may include polypropylene, polyurethane, or elastomeric compounds, depending on the specific requirements of the application. The material selection and manufacturing process can be adapted to achieve the desired balance of flexibility and structural integrity for the gas guides.

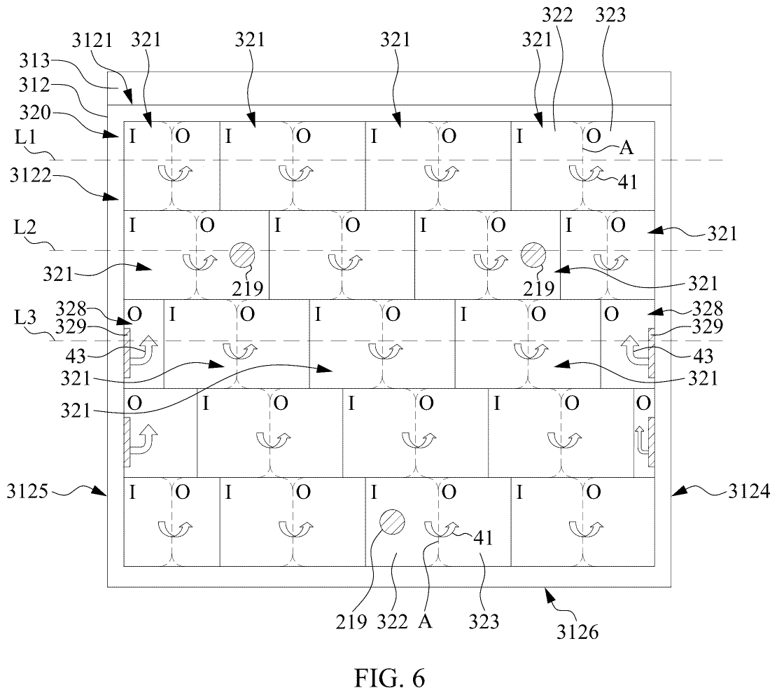

FIG. 6 is a schematic bottom view depicting the cleaning device 300, according to some embodiments of the present disclosure. The gas guides 321 and gas guides 328 may be positioned in an array on the lower plate 3122 of the housing 312. For example, as shown in FIG. 6, the gas guides 321 and the gas guide 328 are arranged on the lower plate 3122 of the housing 312 along multiple reference lines, such as first reference line L1, second reference line L2 and third reference line L3. The first reference line L1, the second reference line L2, and the third reference line L3 are parallel to an open front side 3121 and a rear side 3126 of the housing 312. A door 313 may be detachably connected to the open front side 3121. In addition, the first reference line L1, the second reference line L2, and the third reference line L3 are perpendicular to two opposite lateral sides 3124 and 3125 of the housing. The two lateral sides 3124 and 3125 are perpendicular to the open front side 3121 and the rear side 3126.

In one exemplary embodiment, four gas guides 321 are arranged along the first reference line L1, four gas guides 321 are arranged along the second reference line L2, and three gas guides 321 and two gas guides 328 are arranged along the third reference line L3. The gas guides 321 in the first reference line L1 may have different widths in a direction parallel to the first reference line L1, with the first guiding structure 322 and the second guiding structure 323 arranged in an alternating manner. Similarly, the gas guides 321 in the second reference line L2 may have different widths in a direction parallel to the second reference line L2, with the first guiding structure 322 and the second guiding structure 323 arranged in an alternating manner. In some embodiments, two of the gas guides 321 in the second reference line L2 are positioned so as to allow the insertion of the positioning pins 219 into either the first guiding structure 322 or the second guiding structure 323 of different gas guides 321. The three gas guides 321 in the third reference line L3 may have the same width in a direction parallel to the third reference line L3, while the two gas guides 328 are positioned next to the two lateral sides 3124 and 3125. The filtration member 329 of the two gas guides 328 may face outward to allow gas from the exterior clean room to enter the gas guides 328.

It would be appreciated that the arrangement of the gas guides 321 and 328 can vary from the embodiment shown in FIG. 6, as long as the target cleaning area is covered by the gas guides and the positioning pins 219 of the load port do not interfere with the side walls or diaphragms of the gas guides. In some embodiments, the gas guides may be arranged to cover the entire or nearly the entire lower plate, for example with the ratio of the area occupied by the gas guides to the total area of the lower plate exceeding 95 percent. In alternative embodiments, there may be regions of the lower plate 3122 not occupied by gas guides, forming gaps between gas guides arranged along the same reference lines. In some other embodiments, except for the regions that are located above the positioning pins 219 when the housing 312 is positioned on the load port, which are covered by the gas guides 321 or gas guides 328, the remaining regions may be free of gas guides.

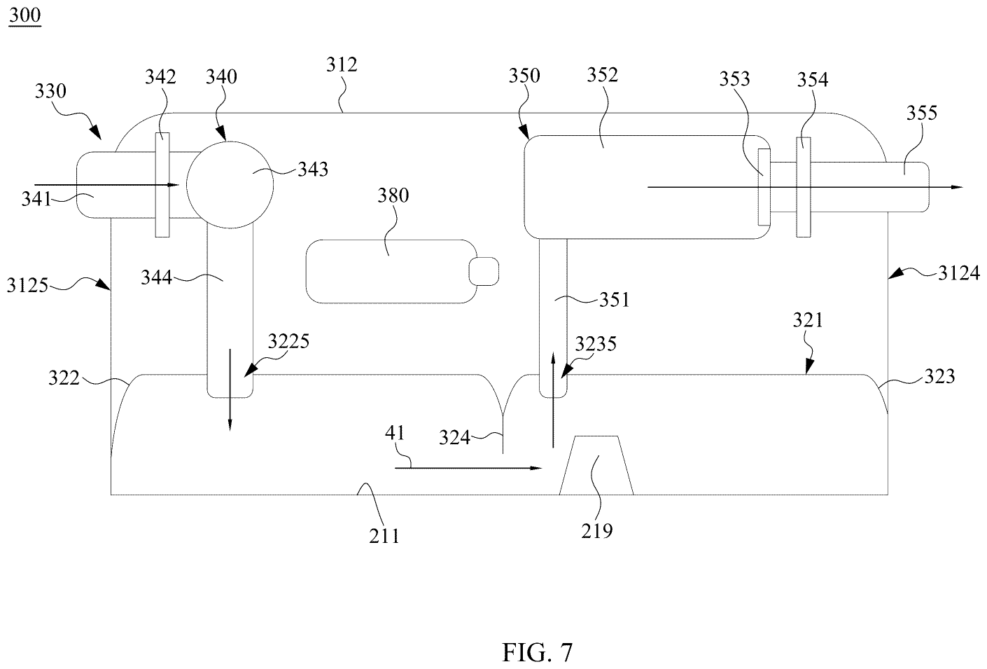

Referring to FIG. 7, in some embodiments, the gas driving member 330 includes a gas feeding assembly 340 and a gas extraction assembly 350. The gas feeding assembly 340 is configured to feed gas to at least one of the gas guides, while the gas extraction assembly 350 is configured to draw gas from at least one of the gas guides. The gas feeding assembly 340 may include various components, such as an inlet conduit 341, one or more filters 342, a flow driving member 343, and a number of gas tubes 344 (FIG. 4 shows multiple gas tubes 344 connecting different gas guides 321). The inlet conduit 341 may be connected to the lateral wall 3125 of the housing 312 to access the exterior of the housing 312. The filter 342 may be connected to the inlet conduit 341, and the flow driving member 343 may be connected between the inlet conduit 341 and the gas tube 344. The gas tube 344 may be connected to a gas hole of one of the gas guides, such as the gas hole 3225 of the first guiding structure 322 of the gas guide 321. When the flow driving member 343 is activated, gas 41 can be drawn into the inlet conduit 341 from the environment and sequentially pass through the filter 342, the flow driving member 343, and the gas tube 344 before being discharged to the first guiding structure 322 of the gas guide 321.

The gas extraction assembly 350 may include various components, such as a number of gas tubes 351 (FIG. 4 shows multiple gas tubes 351 connecting different gas guides 321 and 328), a dust box 352, a filter 353, a flow driving member 354, and an outlet conduit 355. The gas tube 351 may be connected to a gas hole of one of the gas guides, such as the gas hole 3235 of the second guiding structure 323 of the gas guide 321. The dust box 352 may be connected between the outlet conduit 355 and the gas tube 351, with the filter 353 positioned at the outlet of the dust box 352. The flow driving member 354 may be positioned on the outlet conduit 355. When the flow driving member 354 is activated, gas 41 can be drawn out from the gas guide 321 and sequentially pass through the gas tube 351, the dust box 352, the filter 242, and the flow driving member 354 before being exhausted to the environment through the outlet conduit 355.

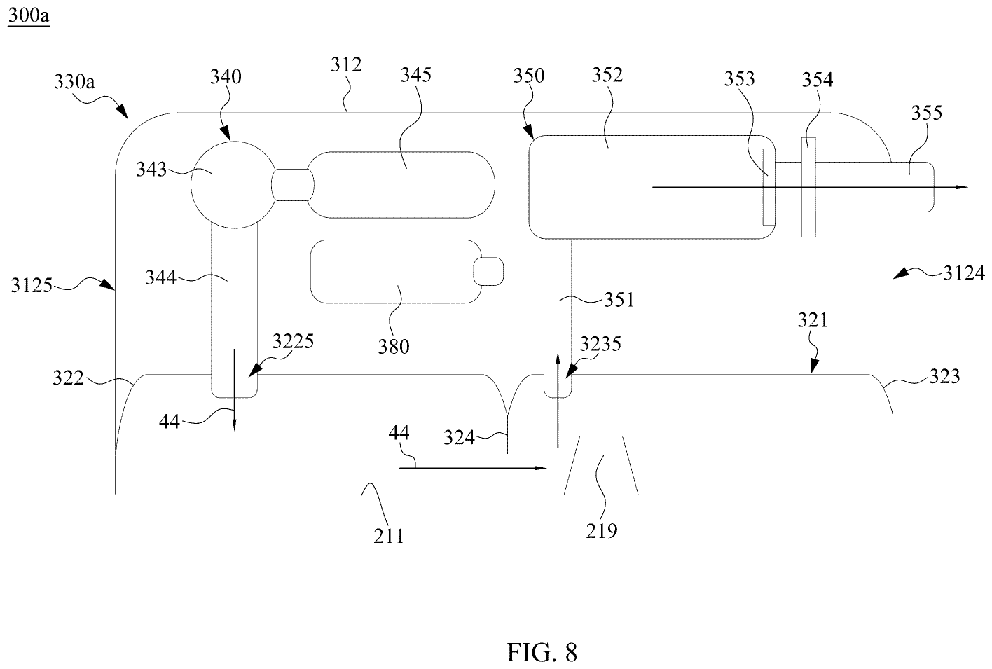

FIG. 8 shows an alternative embodiment of the cleaning device 300a. The main difference between the cleaning device 300a and the cleaning device 300 is that the gas feeding assembly 340 is replaced by the gas feeding assembly 340a. The gas feeding assembly 340a of the gas driving member 330a may include components such as a gas tank 345, one or more filters 342, a flow driving member 343, and a number of gas tubes 344 (FIG. 8 only shows one gas tube). The gas tank 345 may store compressed gas to be used in the cleaning process, such as N2, CO2, or noble gases (He, Ne, Ar, Kr, Xe, Rn). The use of high-purity, filtered gases can help minimize the introduction of contaminants into the load port. The choice of gas may depend on factors such as the specific contaminants being removed and the materials present in the load port. The gas tank 345 may be refillable or replaceable, for continuous operation of the cleaning device.

In some embodiments, a battery 380 may be positioned in the housing 312 to power the flow driving members 343 and 354. The use of a battery can provide a portable and convenient power source for the cleaning device, eliminating external power connections that could potentially introduce contaminants or interfere with the operation of the load port. The battery 380 may be rechargeable. Additionally, as shown in FIG. 4, the flow driving members 343 and 354 may be controlled by the controlling module 360 in response to a signal received from the communication module 370. The communication module 370 may wirelessly communicate with the system controller 140 (FIG. 1) of the automatic system 100. This wireless communication capability allows for seamless integration of the cleaning device with the overall fab control system, enabling remote monitoring, control, and scheduling of cleaning operations. The system controller 140 can send commands to initiate, pause, or stop the cleaning process based on factors such as the fab schedule, processing status, or detected contamination levels. The wireless communication also allows for real-time data collection and analysis, providing valuable insights into the performance and efficiency of the cleaning device and the overall cleanliness of the load port.

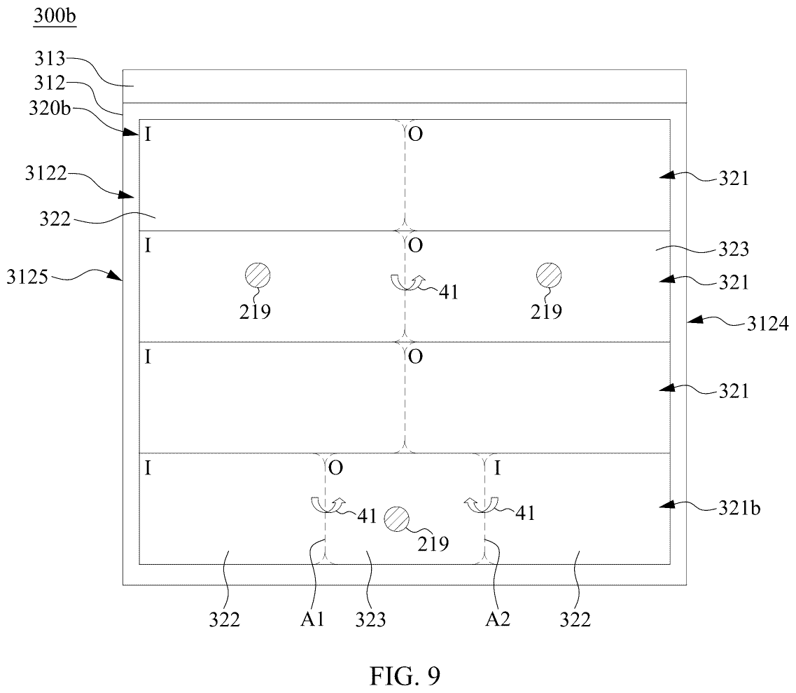

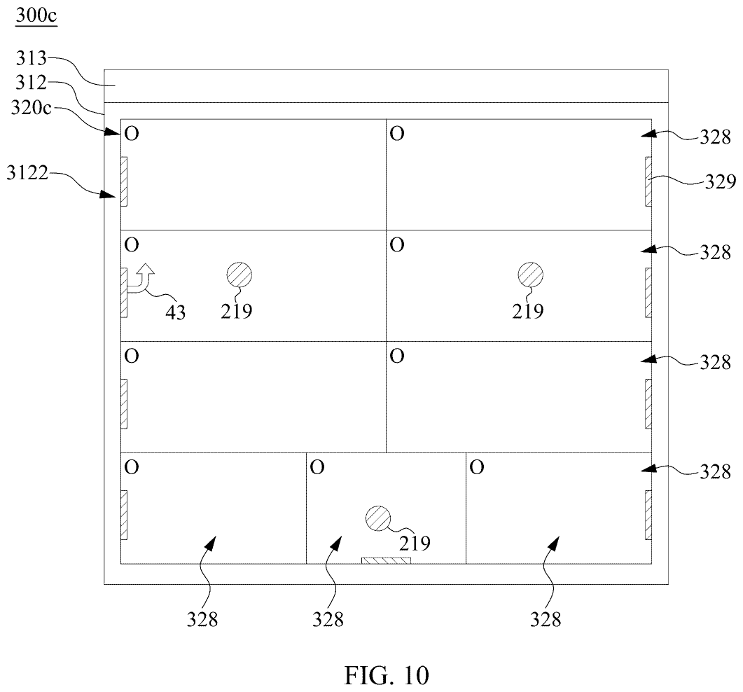

The arrangement of the gas guides is not limited to the embodiments described above and can be adapted to various configurations to suit different application. FIG. 9 illustrates an exemplary embodiment of a covering assembly 320b for a cleaning device 300b, where three gas guides 321 with increased width are disposed on the lower plate 3122 of the housing 312. In this configuration, each gas guide 321 is oriented such that its first guiding structure 322 is positioned adjacent to the lateral side 3125, while its second guiding structure 323 is positioned adjacent to the lateral side 3124. Furthermore, when the housing 312 is placed on a load port, one of the gas guides 321 is capable of covering two positioning pins 219 simultaneously, with one positioning pin 219 being accommodated within the first guiding structure 322 and the other positioning pin 219 being housed within the second guiding structure 323.

In some embodiments, the cleaning device 300b may incorporate an additional gas guide 321b to enhance its cleaning capabilities. The gas guide 321b comprises two first guiding structures 322 and a single second guiding structure 323. The first guiding structure 322 located adjacent to the lateral side 3125 is connected to the second guiding structure 323 via an intermediate axis A1, while the other first guiding structure 322 situated adjacent to the lateral side 3124 is connected to the second guiding structure 323 through an intermediate axis A2. To control the flow in the gas guide 321b, two diaphragms (not depicted in FIG. 9) may be installed between the first and second guiding structures along the intermediate axes A1 and A2. When the housing 312 is positioned on a load port, the second guiding structure 323 of the gas guide 321b is to cover one positioning pin 219 of the load port. By strategically controlling the flow of gas 41 within the gas guide 321 and the gas guide 321b, the cleaning device 300b can effectively remove particles that have accumulated on or around the positioning pins 219, thereby maintaining a clean and contaminant-free environment in the load port area.

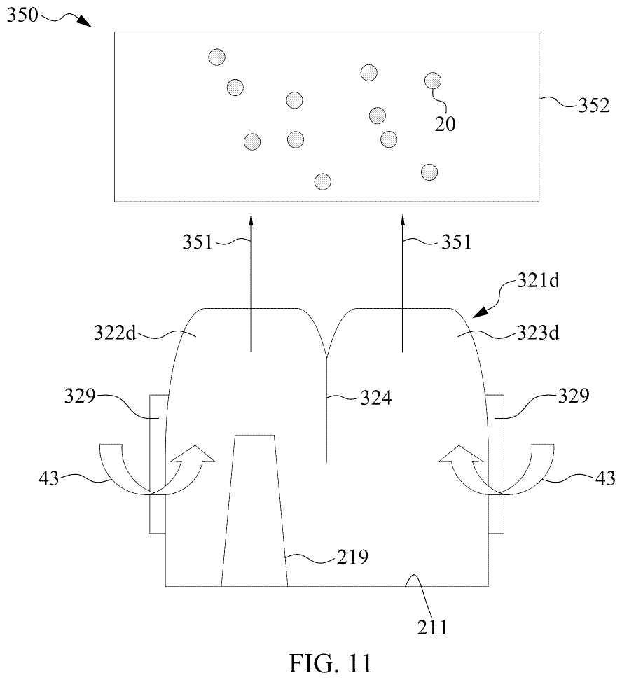

FIG. 11 shows an alternative embodiment of a gas guide 321d. The difference between the gas guide 321d and the gas guide 321 shown in FIG. 5 is that the gas guide 321d further includes two filtration members 329 formed at the side walls of the first guiding structure 322d and the second guiding structure 323d. In addition, two gas tubes 351 are connected to the first guiding structure 322d and the second guiding structure 323d to lead gas from the gas guide 321d to the dust box 352 of the gas extraction assembly 350. In operation, the flow of gas 43 from the environment enters the gas guide 321d by passing through the filtration members 329 and is removed from the gas guide 321d by the gas tubes 351. The filtration members 329 serve to filter the gas 43, trapping particles and contaminants before they enter the gas guide 321d. This helps to maintain a clean environment within the gas guide 321d and prevents the recirculation of particles. The filtered gas is then drawn out of the gas guide 321d through the gas tubes 351 and into the dust box 352, where any remaining particles are collected.

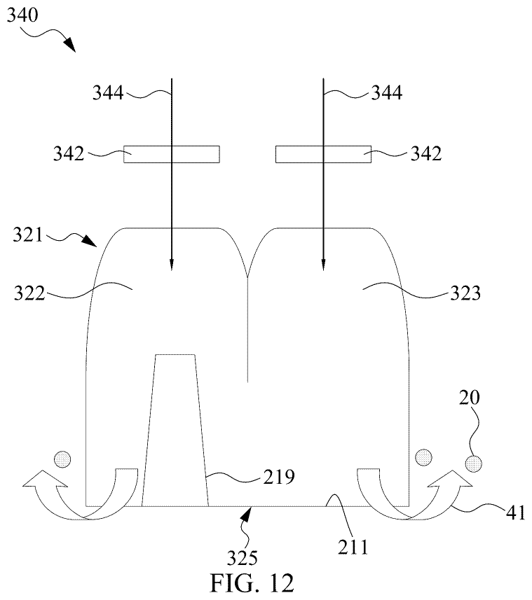

FIG. 12 shows a various application of the gas guide 321, in accordance with some embodiments in the present disclosure. In these embodiments, the first guiding structure 322 and the second guiding structure 323 are both connected to the gas tube 344 of the gas feeding assembly 340. In operation, gas 41 is discharged into the gas guide 321 through the gas tubes 344 and leaves the gas guide 321 through the lower opening 325 of the gas guide 321 directly. The gas 41 may be first filtered by the filters 342 to remove any particles or contaminants, ensuring a clean flow of gas into the gas guide 321. The gas is then discharged through the gas tubes 344 and into both the first guiding structure 322 and the second guiding structure 323. This configuration allows for a direct, focused flow of clean gas onto the surface of load port.

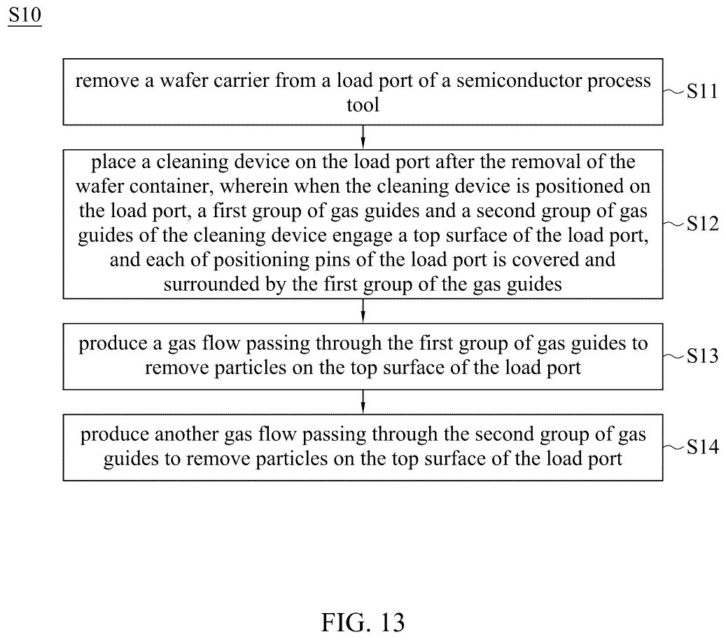

FIG. 13 is a flow chart depicting a method for cleaning a semiconductor manufacturing tool, according to some embodiments of the present invention. For illustration, the flow chart will be described along with the drawings shown in FIGS. 4, 5, and 14-21. Some of the described stages can be replaced or eliminated in different embodiments.

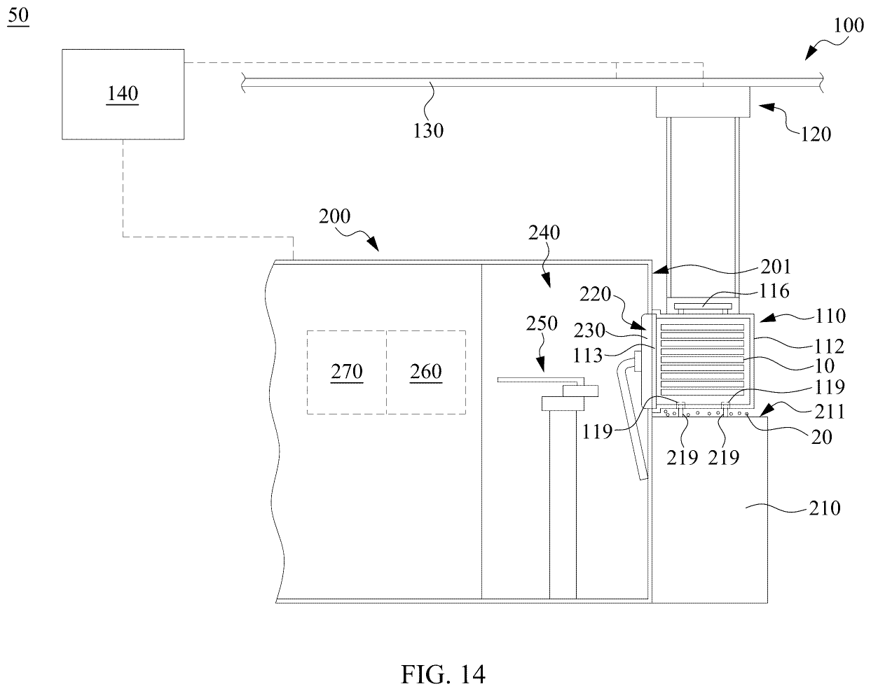

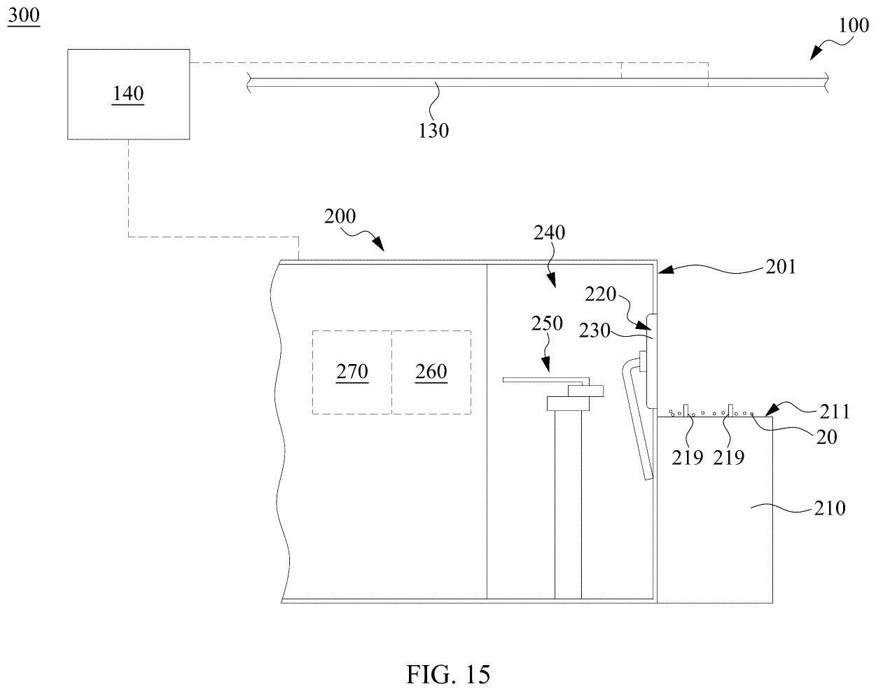

The method S10 includes operation S11, in which a wafer carrier is removed from a load port of a semiconductor process tool. In some embodiments, as illustrated in FIG. 14, following the processing of the wafers 10 by the semiconductor process tool 200, the wafers 10 are loaded into the wafer carrier 110 and prepared for transfer to the next destination by the automatic system 100. To remove the wafer carrier 110, the transport mechanism 120 is controlled to lower and lift the wafer carrier 110 from the load port 210. The transport mechanism 120, carrying the wafer carrier 110, is then moved along the rail 130 to another destination in response to a control signal issued by the system controller 140. After the removal of the wafer carrier 110, as depicted in FIG. 15, particles 20 may accumulate on the top surface 211 of the load port 210.

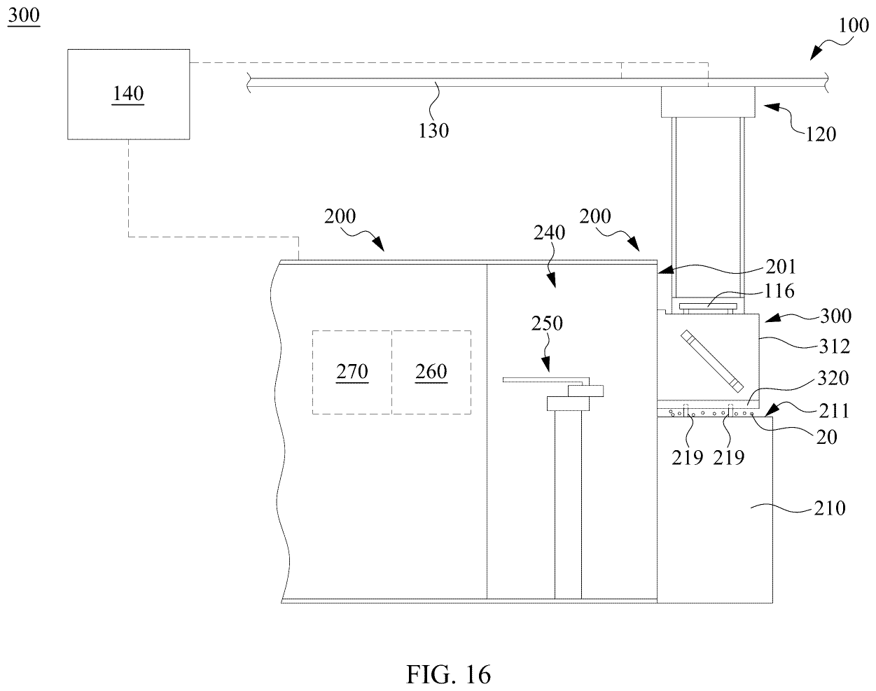

The method S10 includes operation S12, in which a cleaning device is placed on the load port after the removal of the wafer carrier. In some embodiments, as shown in FIG. 16, the cleaning device 300 may be delivered to the load port 210, which has accumulated particles 20, to clean the load port 210. The delivery of the cleaning device 300 can be performed by the transport mechanism 120, which is controlled by the system controller 140. The system controller 140 may be programmed to send the cleaning device 300 to the load port based on a predetermined schedule or in response to real-time contamination detection results. In the case of a predetermined schedule, the system controller 140 may be configured to dispatch the cleaning device 300 after a specific number of wafer carrier runs on the load port. This approach allows regular cleaning intervals, preventing the gradual accumulation of particles over time. Alternatively, the system controller 140 can utilize real-time contamination detection data to make informed decisions about when to deploy the cleaning device 300. Advanced sensors or monitoring systems can be integrated into the load port to continuously assess the level of contamination on its surface.

In some embodiments, as illustrated in FIG. 16, when the cleaning device 300 is positioned on the load port 210, the covering assembly 320 of the cleaning device 300 faces the top surface 211 of the load port 210. At this time, as shown in FIGS. 4 and 5, the gas guides 321 (and/or gas guides 328) are placed on the top surface 211 of the load port 210, with the positioning pins 219 inserted into some of the gas guides 321. A gas-tight seal may be created in each of the gas guides 321/328 by contacting the sealing member 327 with the top surface 211 of the load port 210, utilizing the weight of the cleaning device 300 pressing on the load port 210. After the cleaning device 300 is properly positioned on the load port 210, the gas driving member 330 is actuated (operations S13 and S14) to create a flow of gas passing through the top surface 211 of the load port 210 to remove particles 20.

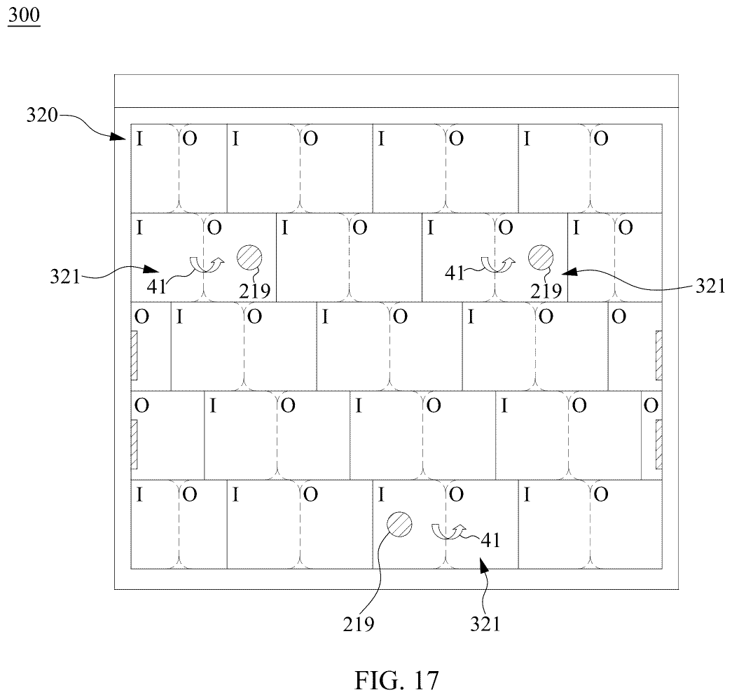

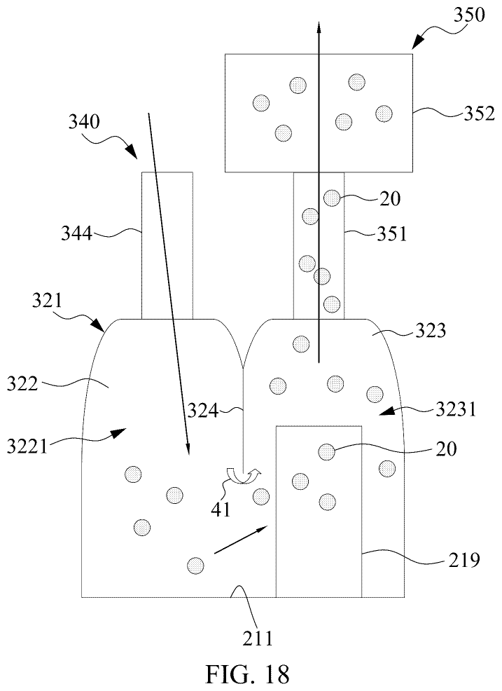

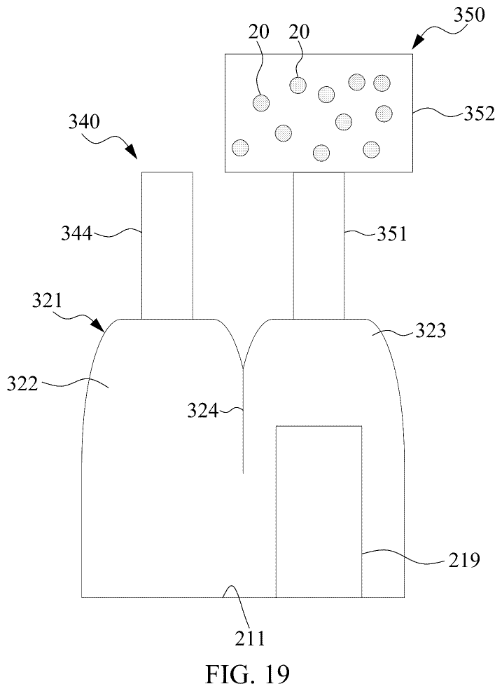

In operation S13, a flow of gas is produced to pass through the first group of gas guides to remove particles on the top surface of the load port. In some embodiments, as shown in FIG. 17, the flow of gas 41 is produced in a first group of gas guides 321 that covers the positioning pins 219, while the remaining gas guides are not supplied with gas. As depicted in FIG. 18, when the flow of gas 41 enters the first channel 3221 of the first guiding structure 322, the flow of gas 41 is guided by the diaphragm 324 to reach the lower portion of the gas guide 321, effectively cleaning the top surface 211 and the positioning pin 219. The flow of gas then enters the second channel 3231 and carries the particles into the dust box 352 through the gas tube 351. As illustrated in FIG. 19, after the supply of gas is maintained for a period, particles on or surrounding the positioning pins 219 or on the top surface 211 are removed.

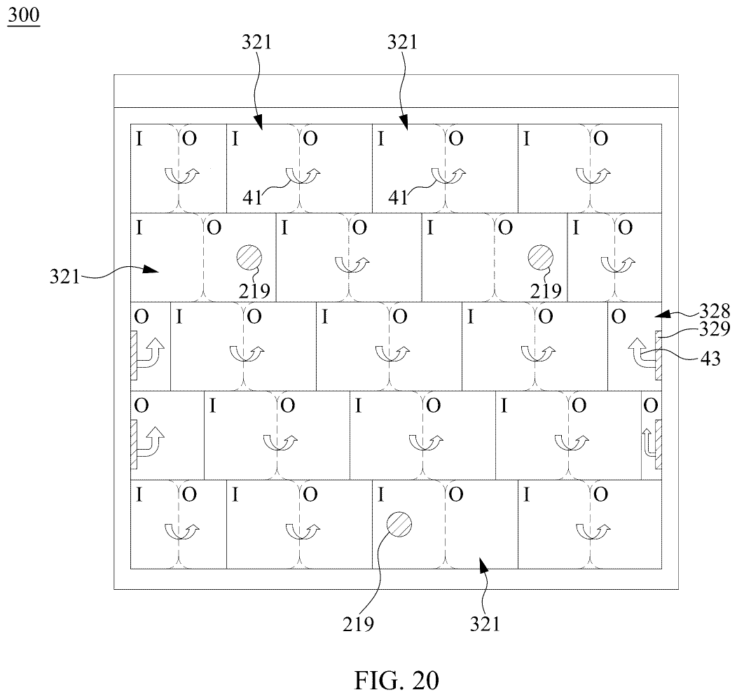

In operation S14, a flow of gas is produced to pass through the second group of gas guides to remove particles on the top surface of the load port. In some embodiments, as shown in FIG. 20, the flow of gas 41 and flow of gas 43 are produced in a second group of gas guides 321 and 328 that do not cover the positioning pins 219, while the gas guides 321 covering the positioning pins 219 are not supplied with gas. Operation S14 is performed to remove particles on other regions that are away from the positioning pins 219.

In some embodiments, operation S14 may be performed after the completion of operation S13. Alternatively, operations S13 and S14 may be performed simultaneously. In cases where operations S13 and S14 are initiated at the same time, operation S14 may be stopped earlier than operation S13. This sequential or simultaneous execution of operations S13 and S14 allows for efficient cleaning of the load port, effectively removing particles from both the positioning pins and the surrounding areas.

In some embodiments, the flow of gas in operation S13 is supplied at a higher flow rate than that supplied in operation S14. This higher flow rate in operation S13 is advantageous because it provides a more forceful and targeted cleaning action on the positioning pins. In some embodiments, gas that is capable of chemically reacting with particles is supplied in operation S13, while environmental gas is supplied in operation S14. The use of a chemically reactive gas in operation S13 enhances the cleaning effectiveness on the positioning pins, as it can break down and remove stubborn particles that may not be easily dislodged by mechanical force alone. Furthermore, the use of environmental gas in operation S14 helps to minimize operational costs while still providing adequate cleaning performance for the larger area covered by the second group of gas guides. In some embodiments, a gas flow is produced in operation S13 and/or operation S14 by periodically generating a gas burst to dislodge and remove particles that may be resistant to continuous gas flow, thereby improving the overall cleaning efficiency of the system.

Embodiments of the present invention provide a cleaning device and method for efficiently removing particles from a load port of a semiconductor process tool. The cleaning device comprises a housing with a base plate that faces the top surface of the load port when positioned. The base plate is equipped with gas guides. Some of the gas guides are designed to cover the positioning pins on the load port, while others are placed in regions away from the positioning pins. A gas driving member is used to generate a flow of gas through the gas guides to remove particles, and the flow of gas in the gas guide may be guided by diaphragms to reach the lower portions of the gas guides. With the cleaning device, particles that have accumulated on or around the positioning pins can be removed, thereby maintaining a clean and contaminant-free environment in the load port area.

According to one embodiment of present disclosure, a cleaning device adapted to be conveyed by a transport mechanism in a semiconductor manufacturing system is provided. The cleaning device includes a housing, having a lower plate. The cleaning device also includes a gas driving member positioned in the housing. In addition, the cleaning device includes a number of gas guides positioned on the lower plate of the housing. As least one of the gas guides forms a lower opening and includes a first guiding structure, a second guiding structure, and a diaphragm. The second guiding structure connects with the first guiding structure along an intermediate axis, wherein the first and the second guiding structures cooperatively form a periphery of the lower opening. The diaphragm extends along the intermediate axis to divide the gas guide into a first channel and a second channel, wherein each of the first and the second channels are fluidly connected with the gas driving member.

According to another embodiment of present disclosure, a semiconductor manufacturing system is provided. The system includes a semiconductor process tool. The semiconductor process tool includes a load port including a plurality of positioning pins positioned on a top surface thereof. The system further includes a cleaning device used to be positioned on the load port. The cleaning device include a housing, a gas driving member, and a number of gas guides. The housing has a lower plate. The gas driving member is positioned in the housing. The gas guides are positioned on the lower plate of the housing and fluidly connected to the gas driving member. When the cleaning device is positioned on the load port, each of the positioning pins of the load port is covered by and surrounded by the lower opening of one of the gas guides.

According to yet another embodiment present disclosure, a method for cleaning a semiconductor manufacturing tool is provided. The method includes removing a wafer carrier from a load port of a semiconductor process tool, wherein when the wafer carrier is positioned on the load port, a plurality of positioning pins formed on a top surface of the load port are inserted into a plurality of positioning holes formed on the lower plate of the wafer carrier. The method also includes placing a cleaning device on the load port after the removal of the wafer carrier. When the cleaning device is positioned on the load port, a first group of gas guides and a second group of gas guides of the cleaning device engage the top surface of the load port, wherein each of the positioning pins of the load port is covered and surrounded by the first group of the gas guide. The method further includes producing a gas flow passing through the first group of gas guides to remove particles on the top surface of the load port.

The foregoing outlines structures of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A device comprising:
a housing, having a lower plate;
a gas driving member positioned in the housing; and
a plurality of gas guides positioned on the lower plate of the housing, wherein at least one of the gas guides forms a lower opening and comprises:
a first guiding structure;
a second guiding structure connecting with the first guiding structure along an intermediate axis, wherein the first and the second guiding structures cooperatively form a periphery of the lower opening; and
a diaphragm extending along the intermediate axis to divide the gas guide into a first channel and a second channel, wherein each of the first and the second channels are fluidly connected with the gas driving member.

2. The device of claim 1, wherein the gas driving member comprises a gas extraction assembly configured to draw gas from the at least one of the gas guides.

3. The device of claim 2, wherein the gas driving member further comprises a gas feeding assembly configured to feed gas to the at least one of the gas guides, wherein the gas feeding assembly and the gas extraction assembly are respectively fluidly connected to the first guiding structure and the second guiding structure of the at least one of the gas guides.

4. The device of claim 2, wherein the at least one of the gas guides comprises a filtration member formed at either the first guiding structure or the second guiding structure.

5. The device of claim 1, wherein the gas guides are arranged in an array on the lower plate of the housing, and a ratio of an area occupied by the gas guides to an area of the lower plate of the housing is greater than 95 percent.

6. The device of claim 1, wherein each of the gas guides further comprises a sealing member surrounding the lower opening.

7. The device of claim 1, wherein the first channel and the second channel extend in a direction perpendicular to the lower plate of the housing and positioned adjacent to each other, and the diaphragm separates upper portions of the first channel and the second channel that are away from the lower opening.

8. A semiconductor manufacturing system, comprising:
a semiconductor process tool comprising a load port, wherein the load port comprises a plurality of positioning pins positioned on a top surface thereof; and
a cleaning device configured to be positioned on the load port and comprising:
a housing, having a lower plate;
a gas driving member positioned in the housing; and
a plurality of gas guides positioned on the lower plate of the housing and fluidly connected to the gas driving member,
wherein when the cleaning device is positioned on the load port, each of the positioning pins of the load port is covered by and surrounded by a lower opening of one of the gas guides.

9. The system of claim 8, further comprising:
a wafer carrier configured to store at least one semiconductor wafer, wherein a lower plate of the wafer carrier includes a plurality of positioning holes;
wherein both the wafer carrier and the cleaning device is adapted to be positioned on the load port, and when the wafer carrier is positioned on the load port, the positioning pins of the load port are inserted into the positioning holes of the wafer carrier.

10. The system of claim 9, further comprising:
a transport mechanism configured to convey the wafer carrier or the cleaning device to the load port or remove the wafer carrier or the cleaning device from the load port.

11. The system of claim 8, wherein one of the gas guides covering the positioning pins comprises:
a first guiding structure;
a second guiding structure connecting with the first guiding structure along an intermediate axis, wherein the first and the second guiding structures cooperatively form a periphery of the lower opening; and
a diaphragm extending along the intermediate axis to partially separate the first guiding structure from the second guiding structure.

12. The system of claim 11, wherein two positioning pins of the plurality of positioning pins are respectively positioned in the first guiding structure and the second guiding structure of the same gas guide.

13. The system of claim 11, wherein one positioning pin of the plurality of positioning pins is positioned in the first guiding structure, and the second guiding structure is free of any positioning pin.

14. The system of claim 11, wherein the gas driving member is configured to supply gas to the first guiding structure and pump out gas from the second guiding structure.

15. The system of claim 8, wherein the gas driving member is configured to pump out gas from the one of the gas guides covering the positioning pins, and the one of the gas guides covering the positioning pins each comprise a filter positioned at a side wall thereof.

16. A method, comprising:
removing a wafer carrier from a load port of the semiconductor process tool, wherein when the wafer carrier is positioned on the load port, a plurality of positioning pins formed on a top surface of the load port are inserted into a plurality of positioning holes formed on the wafer carrier;
placing a cleaning device on the load port after the removal of the wafer carrier, wherein when the cleaning device is positioned on the load port, a first group of gas guides and a second group of gas guides of the cleaning device engage the top surface of the load port, wherein each of the positioning pins of the load port is covered and surrounded by the first group of the gas guides; and
producing a gas flow passing through the first group of gas guides to remove particles on the top surface of the load port.

17. The method of claim 16, wherein the producing a gas flow through the first group of the gas guides comprises:
supplying the gas flow into a first guiding structure of the first group of gas guides; and
removing the gas flow from a second guiding structure of the first group of gas guides, wherein the gas flow in the first group of gas guides flows along a diaphragm before reaching the top surface of load port, the diaphragm partially separates the first guiding structure from the second guiding structure.

18. The method of claim 16, wherein the producing a gas flow through the first group of gas guides comprises removing the gas, which enters first group of gas guides through a filter formed at a side wall of the at least one gas guide, from the first group of gas guides.

19. The method of claim 16, wherein producing a gas flow through the first group of gas guides comprises periodically generating a gas burst using a gas driving member.

20. The method of claim 16, further comprising producing another gas flow passing through the second group of gas guides.
